(19) United States
(12) Patent Application Publication
(10) Pub. No.: US 2009/0165623 A1
(43) Pub. Date: Jul. 2, 2009

(54) RIP SLED

(76) Inventor: MICHAEL A. WHEBY, Wheaton, IL (US)

Correspondence Address: CARDINAL LAW GROUP;Suite 2000, 1603 Orrington Avenue, Evanston, IL, 60201, US

(21) Appl. No.: 12/344,391

(22) Filed: Dec. 26, 2008

Related U.S. Application Data
(60) Provisional application No. 61/017,498, filed on Dec. 28, 2007.

(51) Int. Cl. B26D 7/06; B26D 7/27; B23P 19/04

(52) U.S. Cl. 83/438; 83/522.11; 29/700

(57) ABSTRACT

The invention relates to a method and device adapted to engage a workpiece and provide a rip guide therefore. One embodiment comprises a base, a guide and a support member. The base has two opposing surfaces and a peripheral surface extending there between. The guide is moveably attached to the peripheral surface and is adapted to moveably engage at least one of the two opposing surfaces. The support member is adapted to moveably engage the peripheral surface, wherein at least one of the guide, the at least one of two opposing surfaces and the support member is adapted to engage the workpiece and provide a guide to rip the workpiece,

### RELATE APPLICATION INFORMATION

The application claims priority to, and benefit from, U.S. Provisional Application No. 61/017,498 filed Dec. 28, 2007, the contents of which are incorporated herein by reference.

### FIELD OF THE INVENTION

Embodiments of the invention relate to a device and method for ripping sheet material. More particularly, embodiments of the invention relate to an adjustable device and method for ripping sheet material.

### BACKGROUND OF THE INVENTION

Devices for ripping material (wood for example) are well known in the art. One of the best known methods for ripping materials is a table saw used with long outfeed tables. However, such outfeed tables are not only expensive but may be impractical to move from site to site.

One possible solution to building bookshelves, cabinets, shelving, etc. on site is to use a portable table saw. However such portable table saws tend to tip over when used to cut heavy sheets of large material (4×8 or greater for example). One option is to use portable roller stands with the portable table saw, but such stands are time consuming to set up and take down, especially for a few cuts. Another option is to have a second person guide the material.

Still another possible solution is to use a circular saw with a rip guide. The option is viable for ripping material only a few inches wide, where accuracy is not important. However circular saws and rip guides are impractical for cutting wide pieces, as the guide may flex. Also circular saws require using a tape rule or some other external measuring device to set it up as the guide marks they may have are typically not very accurate.

Still another possible solution is to use a straight edge clamped or otherwise attached to the material. This method provides an accurate cut but requires a great deal of setup time including measuring, marking the material, clamping each end and then repeating the process for each cut.

It would, therefore, be desirable to provide a lightweight, simple and affordable device and method for ripping material or a workpiece that is easy to set up, use and reuse.

### SUMMARY OF THE INVENTION

One aspect of the invention relates to device adapted to engage a workpiece and provide a guide for ripping material. The device comprises a base, a guide and a support member. The base comprises two opposing surfaces and a peripheral surface extending there between. The guide is configured to translate along the peripheral surface and adapted to moveably engage at least one of the two opposing surfaces. The support member is adapted to moveably engage the peripheral surface, wherein at least one of the guide, the at least one of the two opposing surfaces and the support member is adapted to engage the workpiece and provide a guide for ripping the workpiece.

Still another embodiment relates to a device comprising a rectangular base, a support member, a guide, a lock and first and second scales. The rectangular base includes a peripheral surface and first and second receiving holes defined in the peripheral surface, where the second receiving hole is space apart from the first receiving hole. The support member includes a mating surface configured to substantially mate with the peripheral surface and first and second bars, the first bar extending from the mating surface and sized to be moveably received in the first receiving hole and the second bar space from the first bar, extending from the mating surface and sized to be moveably received in the second receiving hole. The guide is configured to translate along the rectangular base and includes a translation surface configured to moveably engage the rectangular base and a locking edge approximate the peripheral surface. The lock is configured to engage the locking edge and rectangular base, locking the guide in a predetermined position. The first scale includes a first predetermined range (a sequential range for example) between a first value and a second value; and the second scale includes a second predetermined range (a sequential range for example) between the second value and a third value.

In at least one embodiment, the support member translates between a first position and a second position. The device may include an indicator used with the first scale when the support member is in the first position and with the second scale when the support member is in the second position.

Yet another embodiment relates to a method for providing a rip guide for a workpiece using a rip sled. In this embodiment, the method comprises determining a size of the workpiece and determining a position for a guide on at least one of two opposing surfaces of the rip sled based at least in part on the determined size. The guide is positioned and locked. The position or length of the support member is determined based at least in part on the determined size. If necessary, the support member is extended from a peripheral surface of the rip sled. The rip sled is positioned on the workpiece such that at least one of the guide, the at least one of the two opposing surfaces and the support member engage the work piece.

Still another embodiment, relates to a method for ripping a workpiece, comprising: receiving the workpiece having an actual size and determining a desired size of the workpiece, where the desired size is less than the actual size. The method further comprises adjusting a rip sled based on the actual and desired sizes and locking the rip sled based on such adjustment. The rip sled is placed on the workpiece and ripped.

Still other embodiments relate to adjusting the rip sled comprises translating a support member to a first position relative to the rip sled.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a perspective view of the rip sled in accordance with one embodiment of the present invention;

FIG. 2 depicts a high level flow diagram depicting a method of positioning a rip sled on a work piece in accordance with one embodiment of the present invention;

FIG. 3 depicts an alternative embodiment of the rip sled of FIG. 1 engaging a workpiece in accordance with one embodiment of the present invention;

FIG. 4 depicts another view of the rip sled of FIG. 3 engaging the workpiece in accordance with one embodiment of the present invention; and

FIG. 5 depicts still another view of the rip sled of FIG. 3 engaging the workpiece in accordance with one embodiment of the present invention.

FIG. 6 depicts an alternative embodiment of the rip sled of FIG. 1 engaging a workpiece in accordance with one embodiment of the present invention;

FIG. 7 depicts another view of the rip sled of FIG. 3 engaging the workpiece in accordance with one embodiment of the present invention; and

FIG. 8 depicts still another view of the rip sled of FIG. 3 engaging the workpiece in accordance with one embodiment of the present invention.

Throughout the various figures, like reference numbers refer to like elements.

### DETAILED DESCRIPTION OF PRESENTLY PREFERRED EMBODIMENTS

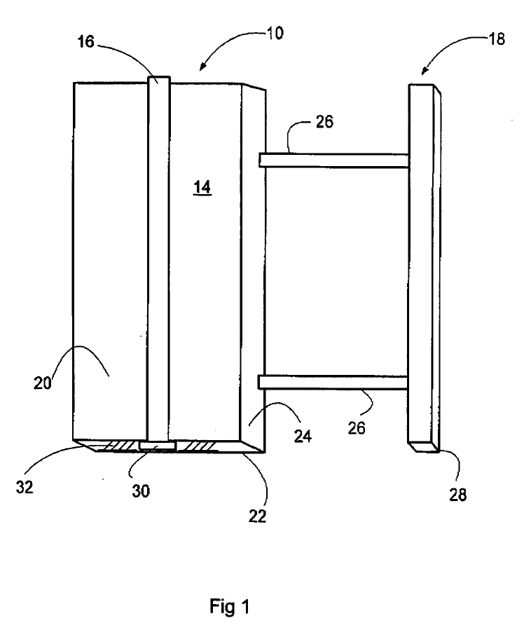

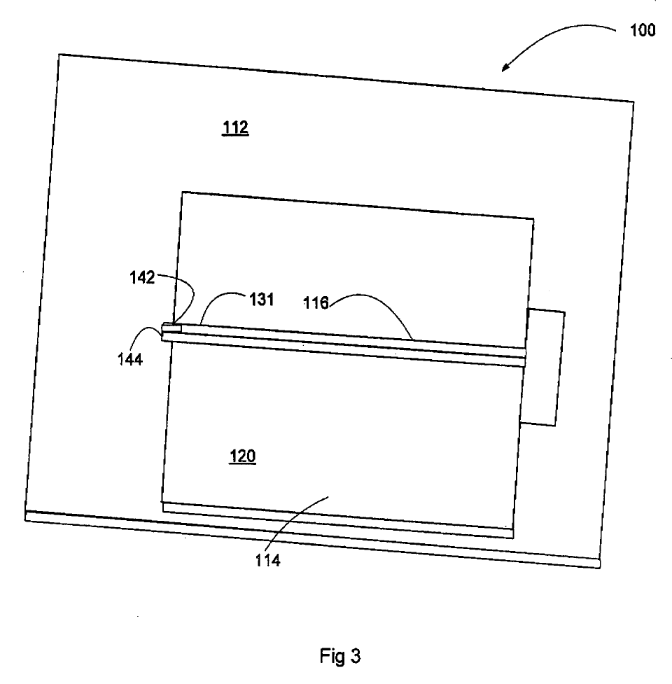

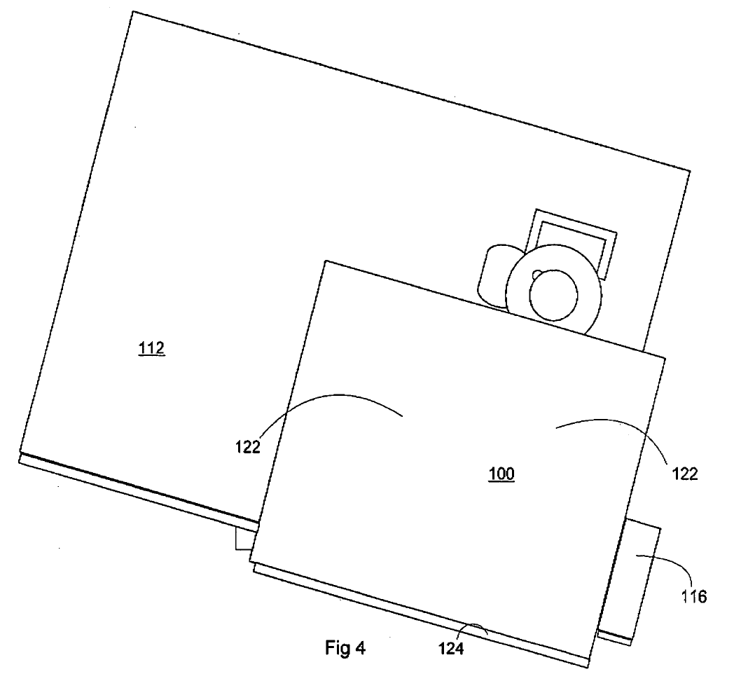

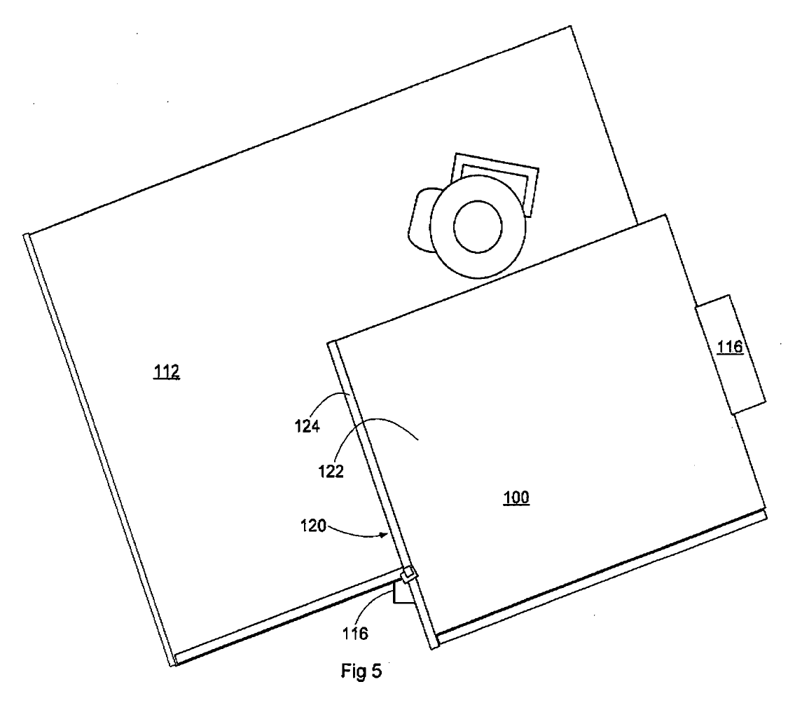

FIG. 1 depicts a rip sled or rip guide, generally designated 10, in accordance with one embodiment of the present invention, where the rip sled 10 is adapted to engage a workpiece (best viewed in FIGS. 3-5) and provide a guide for ripping the material. In at least one embodiment, the device 10 comprises a rectangular base 14, a guide 16 and a support member 18. In one embodiment, the device 10 includes a handle (not depicted). Base 14 has two opposing surfaces 20 and 22 and a peripheral surface 24 extending there between. In at least one embodiment, the device 10 is formed such that at least one, but generally the entire guide 16, at least one of the two opposing surfaces 20 and 22 (surface 20 for example) and the support member 18 are adapted to engage the workpiece. It should be appreciated that, depending on the size of the work, device 10, comprising at least one, but generally all of the guide 16, at least one of the two opposing surfaces 20 and 22 and the support member 18 are adapted to moveably engage the workpiece.

As illustrated, the rectangular base includes two receiving holes, first receiving hole 25 and second receiving hole 27. Both receiving holes 25 and 27 are defined or formed in peripheral edge 24, spaced apart from each other and configured to receive support bars as provided below.

FIG. 1 further illustrates that support member 18 comprises a support bar 26 and an end piece 28. As depicted, end piece 28 has mating surface 29, configured to substantially mate with the peripheral surface 24 and contacts or is coupled (permanently or removably) to support bars 26. It should be appreciated that while only one support bar 26 and end piece 28 are depicted more than one are contemplated. Further, support bars 26 engage the peripheral surface 24 in an extendable or adjustable manner, where one support bar engages the first receiving hole 25 and the second support bar engages the second receiving hole 27. It is contemplated that support member 18 may translate between a first and second position, extended only for cuts greater than a predetermined size (12 inches for example, although other predetermined sizes are contemplated).

In at least one embodiment, each support arm 26 includes a lock (detent, compression ring, pin or bolts for example, although any other suitable locking member is contemplated) configured to lock the arms in position. It should be appreciated that embodiments are contemplated wherein receiving holes 25 and 27 are formed on the mating surface 29. Device 10 illustrated in FIG. 1 further includes guide 16 having at least one locking mechanism 30 proximate locking edge 33 moveably contacting peripheral surface 24.

In at least one embodiment, guide 16 includes a translation surface 31 that moveably contacts at least one of the two opposing surfaces (surface 20 for example). The guide 16 may be moved to a predetermined position on surface 20, and locked in place using locking mechanism 30. Device 10 further includes at least one scale 32 (formed on the peripheral surface for example), used to help position the guide 16. In an alternate embodiment, device 10 includes two sets of scales 32 (formed on the peripheral surface for example), one scale (ranging between 5 and 12 inches for example) used when the support member is in the first (unextended or collapsed) position, and one scale (ranging between 12 and 24 inches for example) used when the support member is in the second (extended) position. In at least one embodiment, device 10 further includes one or more indicators (not shown) used with one or both scales 32.

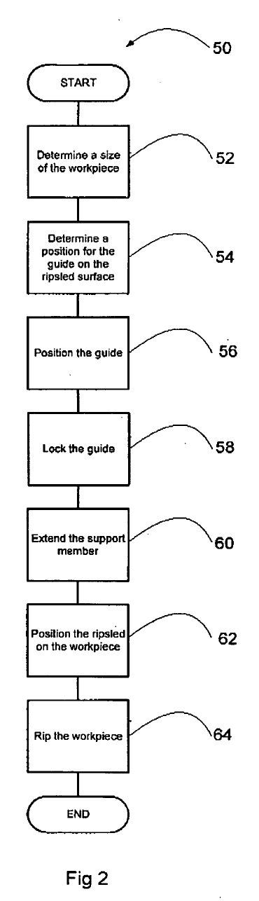

FIG. 2 depicts a high level flow diagram, generally designed 50, depicting a method of positioning a rip sled on a work piece in accordance with one embodiment of the present invention; engaging the workpiece in accordance with one embodiment of the present invention. FIG. 2 depicts method 50 includes determining a size of the workpiece, block 52 and determining a position for a guide on at least one of two opposing surfaces of the rip sled based at least in part on the d size of the workpiece, block 54.

Method 50 further comprises positioning the guide at the predetermined position, block 26 and locking the guide at that position, block 58. Method 50 further comprises determining whether to extend the support member, block 60, depending on the determined size of the workpiece. If necessary depending on the workpiece size, the support member is extended from a peripheral surface of the rip sled. The rip sled is positioned on the workpiece, such that at least one of the guide, the at least one of the two opposing surfaces and the support member engage the work piece, block 32. The workpiece may then be ripped, block 64.

FIGS. 3-5 depict an alternative embodiment of the device, generally designated 100, used in accordance with one embodiment of the present invention, where the rip sled 100 is adapted to engage a workpiece 112 and provide a guide for ripping the material. In at least one embodiment, the device 100 comprises base 114 and a guide 116. Guide 116 has translation surface 131 and one locking mechanism proximate locking edge 144.

Base 114 is depicted having two opposing surfaces 120 and 122 and a peripheral surface 124 extending there between. In at least one embodiment, the device 100 is adapted such that at least one, but generally all of the guide 116 and at least one of the two opposing surfaces 120 and 122 (surface 120 for example) are adapted to engage the workpiece 112. It should be appreciated that, depending on the size of the work, device 100, comprising at least one, but generally all of the guide 116, at least one of the two opposing surfaces 120 and 122 and the support member are adapted to engage the workpiece 112 are adapted to moveably engage the workpiece.

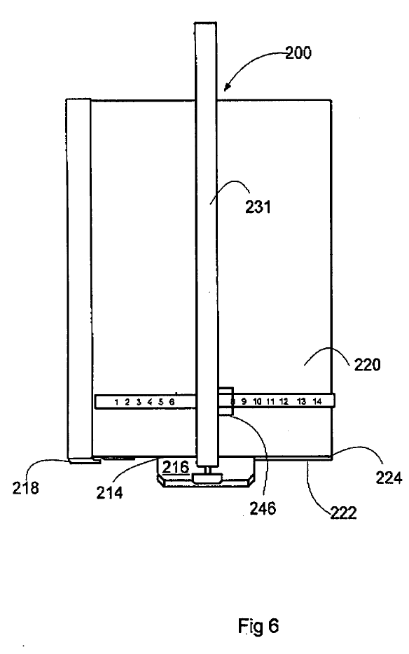

FIGS. 6-8 depict another embodiment the device, generally designated 200, used in accordance with one embodiment of the present invention, where the rip sled 200 is adapted to engage a workpiece 212 and provide a guide for ripping the material. In at least one embodiment, the device 200 comprises base 214 and a guide 216.

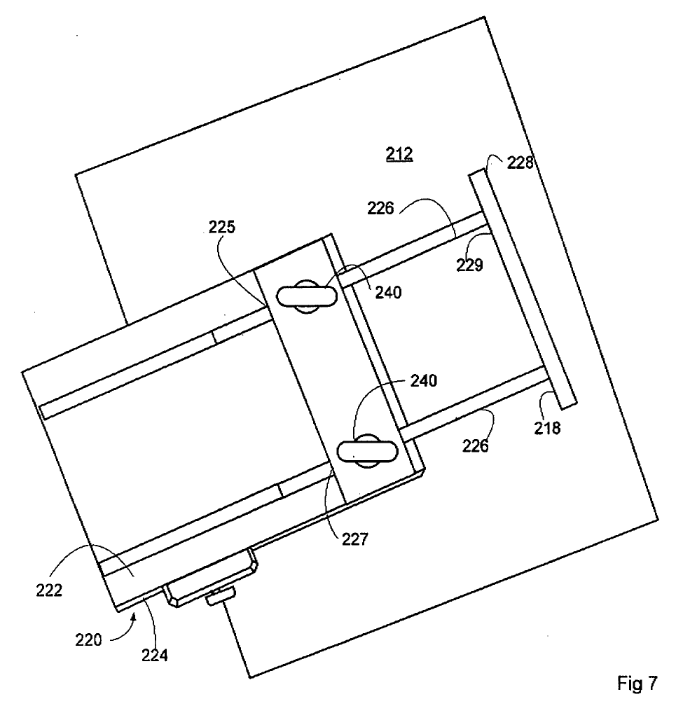

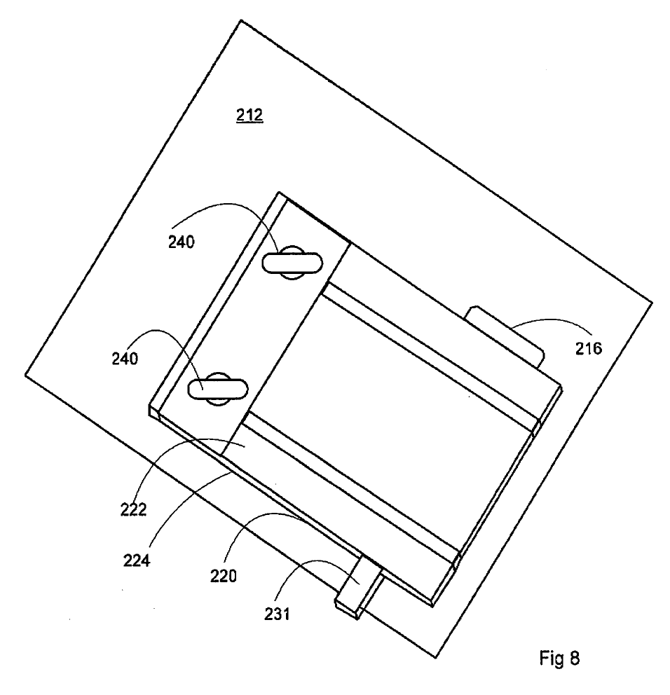

Base 214 is depicted having two opposing surfaces 220 and 222 and a peripheral surface 224 extending there between. In at least one embodiment, the device 200 is adapted such that at least one, but generally all of the guide 216 and at least one of the two opposing surfaces 220 and 222 (surface 220 for example as illustrated in FIGS. 7 and 8) are adapted to engage the workpiece 212. It should be appreciated that, depending on the size of the work, device 200, comprising at least one, but generally all of the guide 216, at least one of the two opposing surfaces 120 and 122 and the support member 218.

FIG. 7 further illustrates that support member 218 comprises at least two support bars 226 and an end piece 228. While two support bars 226 and one end piece 228 are illustrate more or less are contemplated. As depicted, end piece 228 has mating surface 229, configured to substantially mate with the peripheral surface 224 and contacts or is coupled (permanently or removably) to support bars 226. Further, support bars 226 engage the peripheral surface 224 in an extendable or adjustable manner, where one support bar engages the first receiving hole 225 and the second support bar engages the second receiving hole 227. It is contemplated that support member 218 translates between a first and second position, extended only for cuts greater than a predetermined size (12 inches for example, although other predetermined sizes are contemplated).

In at least one embodiment, each support arm 226 includes a lock 240 (wingnut, detent, compression ring, pin or bolts for example, although any other suitable locking member is contemplated) configured to lock the bars 226 in position. It should be appreciated that embodiments are contemplated wherein receiving holes 225 and 227 are formed on the mating surface 229. Device 200 illustrated in FIGS. 6-8 further includes guide 216 (best viewed in FIG. 7) having at least one locking mechanism 242 proximate locking edge 244 moveably contacting peripheral surface 224.

In at least one embodiment, guide 216 includes a translation surface 231 that moveably contacts at least one of the two opposing surfaces (surface 220 for example). The guide 216 may be moved to a predetermined position on surface 220, and locked in place using locking mechanisms 224. Device 200 further includes at least one scale 232 (formed on the peripheral surface for example), used to help position the guide 216. In an alternate embodiment, device 200 includes two sets of scales 232 (formed on the peripheral surface for example), one scale (ranging between 5 and 12 inches for example) used when the support member is in the first (unextended or collapsed) position, and one scale (ranging between 12 and 24 inches for example) used when the support member is in the second (extended) position. In at least one embodiment, device 200 further includes one or more indicators or guide 246 used with one or both scales 232. In at least one embodiment, the indicator 246 indicates a reading, reads on or partially obscures the first scale when the support member is in a first position and indicates a reading, reads on or partially obscures the second scale when said support member is in the second position.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A device comprising:
a rectangular base including:
a peripheral surface;
a first receiving hole defined in said peripheral surface; and
a second receiving hole defined in said peripheral surface and spaced apart from said first receiving hole;
a support member including:
a mating surface, said mating surface configured to substantially mate with said peripheral surface;
a first bar extending from said mating surface and sized to be moveably received in said first receiving hole;
a second bar spaced from said first bar, extending from said mating surface and sized to be moveably received in said second receiving hole;
a guide configured to translate along said rectangular base, said guide including;
a translation surface configured to moveably engage said rectangular base;
a locking edge approximate said peripheral surface;
a lock configured to engage said locking edge and rectangular base, locking said guide in a predetermined position;
a first scale including a first predetermined range between a first value and a second value; and
a second scale including a second predetermined range between said second value and a third value.

2. The device of claim 1 wherein said support member translates between a first position and a second position.

3. The device of claim 2 including an indicator indicating a reading on said first scale when said support member is in said first position and indicating a reading on said second scale when said support member is in said second position.

4. The device of claim 1 wherein said first scale and second scale include sequential values.

5. The device of claim 1 wherein said first scale and second scale are positioned on said peripheral surface.

6. A device adapted to engage a workpiece and provide a guide therefore, the device comprising:
a base having two opposing surfaces and a peripheral surface extending there between;
a guide configured to translate along said peripheral surface and at least one of said two opposing surfaces; and
a support member adapted to moveably engage said peripheral surface, wherein at least one of said guide, said at least one of said two opposing surfaces and said support member is adapted to engage said workpiece.

7. The device of claim 6 further comprising all of said guide, said at least one of said two opposing surfaces and said support member adapted to engage said workpiece.

8. The device of claim 7 wherein said guide, said at least one of said two opposing surfaces and said support member are adapted to moveably engage said workpiece.

9. The device of claim 6 wherein said support member comprises at least one support bar and an end piece, wherein said end piece contacts said at least one support bar and said support bar engages said peripheral surface in an extendable manner.

10. The device of claim 5 further comprising a locking mechanism contacting said guide and said peripheral surface, said locking mechanism adapted to lock said guide in a predetermined position.

11. A method for providing a rip guide for a workpiece using a rip sled, the method comprising:
determining a size of the workpiece;
determining a position for a guide on at least one of two opposing surfaces of the rip sled based at least in part on said size;
positioning said guide at said position;
locking said guide at said position;
determining whether to extend a support member from a peripheral surface of the rip sled based at least in part on said determined size;
positioning the rip sled such that at least one of said guide, said at least one of said two opposing surfaces and said support member engage the work piece thereby providing a guide for ripping the workpiece.

12. The method of claim 11 further comprising extending said support member from said peripheral surface.

13. A method for ripping a workpiece, comprising:
receiving the workpiece, the workpiece including an actual size;
determining a desired size of the workpiece, said desired size less than said actual size;
adjusting a rip sled based on said actual and desired sizes;
locking said rip sled based on said adjustment;
placing said rip sled on the workpiece; and
ripping the workpiece.

14. The method of claim 13, wherein adjusting said rip sled comprises translating a support member to a first position relative to said rip sled.
